(19) United States
(12) Patent Application Publication
(10) Pub. No.: US 2026/0044004 A1
(43) Pub. Date: Feb. 12, 2026

(54) SPECTACLE LENS FOR A DISPLAY DEVICE WHICH CAN BE PLACED ON THE HEAD OF A USER AND WHICH GENERATES AN IMAGE, AND DISPLAY DEVICE COMPRISING SUCH A SPECTACLE LENS

(71) Applicant: tooz technologies GmbH, Aalen (DE)

(72) Inventors: Georg MICHELS, Aalen (DE); Huang Min CHEN, Aalen (DE); Xuan Truong NGUYEN, Berlin (DE)

(21) Appl. No.: 19/101,248

(22) PCT Filed: Jul. 27, 2023
(86) PCT No.: PCT/EP2023/070852

§ 371 Date: Feb. 4, 2025

(30) Foreign Application Priority Data
Aug. 5, 2022 (DE) 102022119744.1

(51) Int. Cl. G02B 27/01

(52) U.S. Cl. CPC G02B 27/0172; G02B 2027/013; G02B 2027/0178

(57) ABSTRACT

A spectacle lens for a display device is provided that can be placed on the head of a user and generates an image. The spectacle lens has a multi-layered structure, including a first layer, a second layer and a third layer. The second layer is arranged between the first and third layers and is connected to the first and third layers. The second layer has a first interface facing the first layer and a second interface facing the third layer. The second layer has at least one first spacer, which protrudes with respect to the first interface and defines the spacing between the second and first layers, and at least one second spacer, which protrudes with respect to the second interface and defines the spacing between the second and third layers.

### PRIORITY

This application claims the priority of German patent application DE 102022119744.1 filed Aug. 5, 2022, which is hereby incorporated herein by reference in its entirety.

### FIELD

The present invention relates to a spectacle lens for a display device which can be placed on the head of a user and generates an image, and also to a display device comprising such a spectacle lens.

### BACKGROUND

Such a spectacle lens is often used in so-called smartglasses, in which there is a constant need to improve the quality of the image presented to the user.

### SUMMARY

An object of the invention is to provide a spectacle lens which, when used in smartglasses, improves as far as possible the quality of the image presented to the user.

A spectacle lens for a display device which can be placed on the head of a user and generates an image comprises a front side and a rear side, an entry portion and a deflecting portion, which is spaced apart from the entry portion, and also an exit portion in the rear side. The spectacle lens also comprises a light-guiding channel, by means of which bundles of light from the generated image that are coupled into the spectacle lens via the entry portion of the spectacle lens are guided in the spectacle lens, by means of at least one reflection (e.g. total internal reflection or reflection at a reflective layer), as far as the deflecting portion, from which they are deflected in the direction of the exit portion and are then coupled out of the spectacle lens by way of the exit portion.

The spectacle lens can be of multi-shell construction and comprise a first shell, a second shell and a third shell, wherein the second shell is arranged between the first and third shells and is connected to the first and third shells. The second shell also comprises a first boundary surface, which is oriented toward the first shell, and a second boundary surface, which is oriented toward the third shell, wherein the second shell comprises at least one first spacer, which projects in relation to the first boundary surface and pre-defines the spacing between the second and first shells, and at least one second spacer, which projects in relation to the second boundary surface and pre-defines the spacing between the second and third shells.

It can thus be ensured, during production of the spectacle lens, that the spacing between the shells that is pre-defined by the optical design is always present. Undesirable variations in the spacing can therefore be reliably avoided even in the case of series manufacturing or when large numbers of items are being manufactured.

The deflecting portion can comprise a plurality of reflective deflecting elements which are arranged one beside the other and, for example in a Fresnel-like manner, can realize a desired deflecting function and possibly a certain imaging function of the deflecting portion. The reflective deflecting elements can be reflective surface pieces, which may also be referred to as reflective facets. The reflective surface pieces can each be of planar design. However, it is also possible for the reflective surface pieces themselves to be of curved design (for example spherically or aspherically curved design).

The reflectivity of the respective reflective deflecting elements can be for example in the range of 2-100% (including the limits of the range). The reflective deflecting elements can therefore be of partly reflective or reflective design.

The spectacle lens can comprise in particular a curved rear side and/or a curved front side. The entry portion can be formed in the rear side. The curved rear side can be realized by that boundary surface of the third shell which is oriented away from the second shell. The curved front side can be formed by that boundary surface of the first shell which is oriented away from the second shell.

### ONE OR MORE COATINGS CAN BE FORMED ON THE FRONT SIDE AND/OR REAR SIDE.

The two facing boundary surfaces of the respective shells can be connected to one another by an adhesive layer (in particular optical adhesive or optical cement). The thickness of the adhesive layer is pre-defined by the projecting spacers and can be for example 30 μm to 1500 μm.

The spacers can be formed in one piece with the second shell.

The facing boundary surfaces of the first and second shells and/or of the second and third shells can be of curved design.

Also provided is a holding device, which can be placed on the head of a user, an image-generating module, which is fastened on the holding device and generates a (monochromatic or polychromatic) image, and a spectacle lens, which is fastened on the holding device. In the state in which the holding device has been placed on the head, the spectacle lens can be used to project the generated image in such a manner that the user can perceive it as a virtual image. The display device can comprise a control unit, which activates the image-generating module. In particular, the control unit can activate the image-generating module on the basis of supplied image data.

The image-generating module or the corresponding image-generator unit can comprise in particular a two-dimensional image generator, for example an LCD module, an LCOS module, an OLED module or a tilting-mirror matrix. Each image generator can comprise a plurality of pixels, which can be arranged for example in rows and columns. Each image generator can be for example self-illuminating or not self-illuminating.

Each image generator can preferably generate a monochromatic image, wherein different image generators generate monochromatic images with different wavelengths. The image-generating module can also be designed in such a manner that a multicolored image is generated.

The image-generating module can thus comprise a polychromatic image generator, a combination of two or more monochromatic image generators, or can comprise a combination of a dichromatic image generator and a monochromatic image generator. Typical configurations of such image-generating modules comprising a plurality of image generators comprise a superimposition unit, by means of which the bundles of light from the plurality of image generators are superimposed to form a common bundle of light. Such a superimposition unit can be realized for example in the form of a beam-splitter cube (also referred to as an X-cube) or a so-called rod combiner, these being known to a person skilled in the art.

It goes without saying that the features mentioned above and the features yet to be explained hereinbelow can be used not only in the specified combinations but also in other combinations or on their own, without departing from the scope of the present invention.

The invention will be explained in more detail hereinbelow on the basis of exemplary embodiments and with reference to the accompanying drawings, which likewise disclose features essential to the invention. These exemplary embodiments serve for illustrative purposes only and should not be interpreted as being limiting. For example, a description of an exemplary embodiment comprising a multiplicity of elements or components should not be interpreted as meaning that all these elements or components are necessary for implementation. Rather, other exemplary embodiments can also contain alternative elements and components, fewer elements or components, or additional elements or components.

Elements or components from different exemplary embodiments can be combined with one another, unless stated otherwise. Modifications and variations that are described for one of the exemplary embodiments can also be applicable to other exemplary embodiments. In order to avoid repetition, the same or corresponding elements in different figures are denoted by the same reference signs and are not explained repeatedly.

### BRIEF DESCRIPTION OF THE DRAWINGS

FIG. 1 shows a schematic perspective illustration of one embodiment of the display device according to certain embodiments of the invention;

FIG. 2 shows an enlarged sectional view of the first spectacle lens, including a schematic illustration of the image-generating module;

FIG. 3 shows an enlarged schematic illustration of the spectacle lens according to FIG. 2;

FIG. 4 shows a schematic illustration for the purpose of explaining the production of the intermediate shell according to FIG. 3;

FIG. 5 shows an enlarged schematic illustration of a variation of the spectacle lens according to FIG. 2; and

FIG. 6 shows a schematic illustration for the purpose of explaining the production of the intermediate shell according to FIG. 5.

### DETAILED DESCRIPTION

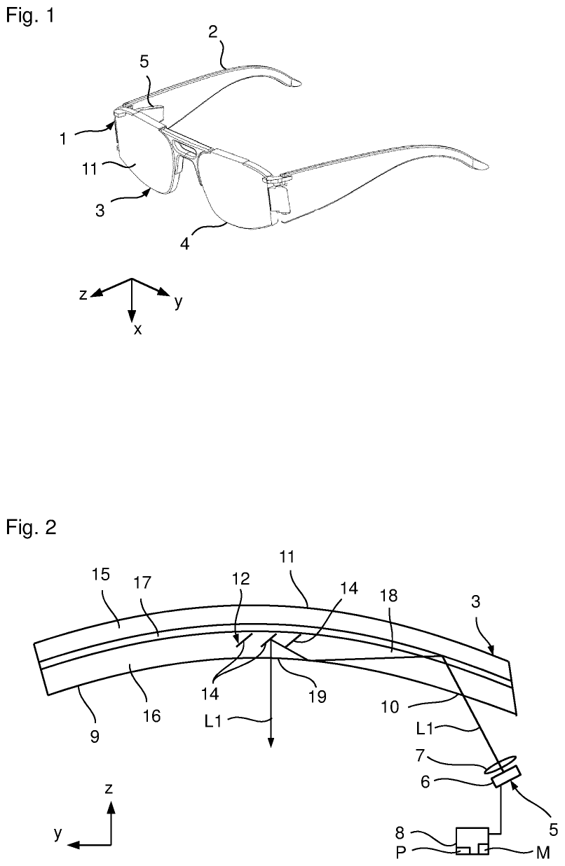

In the case of the embodiment shown in FIG. 1, the display device 1 comprises a holding device 2, which can be placed on the head of a user and can be designed for example in the form of a conventional spectacle frame, and also comprises a first and a second spectacle lens 3, 4, which are fastened on the holding device 2. The holding device 2 with the spectacle lenses 3, 4 can be designed for example in the form of safety glasses or goggles, sports glasses or goggles, sunglasses and/or spectacles for correcting defective vision, wherein a virtual image can be introduced into the user's field of view via the first spectacle lens 3, which is designed in the form of a spectacle lens and which may also be referred to as a multifunctional lens, as described hereinbelow.

For this purpose, the display device 1 comprises an image-generating module 5, which can be arranged in the region of the right-hand spectacle earpiece of the holding device 2, as is illustrated schematically in FIG. 1. The image-generating module 5 can comprise an image-generating element 6 for generating a (monochromatic or multicolored) image and can also comprise an image-generator optical unit 7 disposed downstream of the image-generating element 6 (FIG. 2). The image-generating element 6 can be designed in the form of a two-dimensional image-generating element 6, for example in the form of an OLED element, an LCD element, an LCOS element or a tilting-mirror matrix, each comprising a multiplicity of pixels arranged for example in rows and columns. A single light beam L1 is depicted schematically to represent the bundles of light emitted by the two-dimensional image-generating element 6.

As can also be gathered from FIG. 2, the image-generating module 5 further comprises a control unit 8 comprising for example a processor P and a memory M for activating the image-generating module 5. In dependence on supplied image data, the control unit 8 activates the image-generating module 5, and in particular the image-generating element 6, in such a manner that the desired image is generated and therefore corresponding bundles of light L1 are generated and enter the spectacle lens 3 via a curved rear side 9 thereof. The region of entry at the rear side 9 may also be referred to as entry portion 10.

The spectacle lens 3 further comprises a curved front side 11 and also a deflecting portion 12, which is buried in the spectacle lens 3.

The deflecting portion 12 comprises a plurality of reflective deflecting elements 14, which may also be referred to as first reflective facets. The reflectivity of the reflective deflecting elements 14 can be for example in the range of 2-100%.

It is also illustrated schematically in FIG. 2 that the spectacle lens 3 is of multi-shell design comprising an outer shell 15, an inner shell 16 and an intermediate shell 17, which is arranged therebetween, wherein the facing boundary surfaces of the outer and intermediate shells 15, 17, and also of the intermediate and inner shells 17, 16, are connected by an adhesive. The outer shell 15 may also be referred to as first shell 15, the intermediate shell 17 may also be referred to as second shell 17 and the inner shell 16 may also be referred to as third shell 16.

As has already been described, the bundles of light L1 enter into the spectacle lens 3 via the entry portion 10 in the rear side 9. The bundles of light L1 are then guided in the spectacle lens 3 for example by way of total internal reflection at the rear side 9, and reflection in the intermediate shell 17, as far as the deflecting portion 12, so that there is a light-guiding channel 18 from the entry portion 10 as far as the deflecting portion 12. The deflecting portion 12 then deflects the bundles of light L1 in the direction of the rear side 9 in such a manner that the deflected bundles of light L1 exit from the spectacle lens 3 via the rear side 9. The region via which the bundles of light L1 exit may also be referred to as exit portion 19.

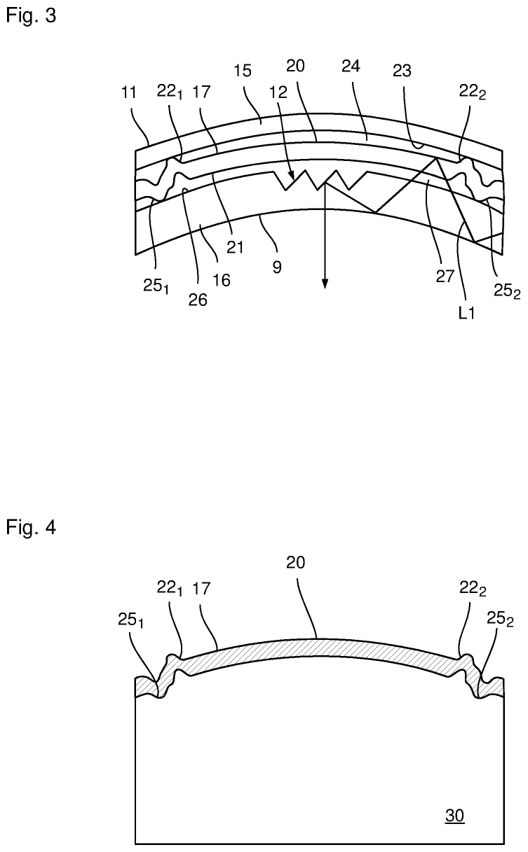

FIG. 3 is an enlarged schematic illustration of part of the right-hand spectacle lens 3. As can clearly be seen, the intermediate shell 17 comprises a first boundary surface 20, which is oriented toward the outer shell 15, and a second boundary surface 21, which is oriented toward the inner shell 16. Formed on the first boundary surface 20 are two first elevated structures 221 and 222, which serve as first spacers. It is thus the case that the boundary surface 23 of the outer shell 15, this boundary surface being oriented toward the intermediate shell 17, rests on the first spacers 221 and 222, which project in relation to the first boundary surface 20 by for example 30 μm to 1500 μm, this thereby defining the spacing between the outer shell 15 and the intermediate shell 17. The two shells 15 and 17 are preferably adhesively bonded to one another, so that the spacing pre-defined by the first spacers 221 and 222 is maintained during the adhesive-bonding process (or the joining process). Use can be made for example of an adhesive 24 of which the refractive index is adapted to that of the basic material of the intermediate and outer shells 17, 15. In this case, a reflective coating can be provided on the first boundary surface 20, in the region of the light-guiding channel 18, in order for the desired reflections to be achieved at the first boundary surface 20. If there is no reflective coating provided, total internal reflection at the front side 11 can also be used in order to ensure light guiding (not shown). As an alternative, the refractive index of the adhesive 24, and possibly of the outer shell 15, can be selected in such a manner that total internal reflection takes place at the first boundary surface 20 or at the boundary surface 23 of the outer shell 15, this boundary surface being oriented toward the intermediate shell 17.

Formed on the second boundary surface 21 are two second elevated structures 251 and 252, which serve as second spacers. It is thus the case that the boundary surface 26 of the inner shell 16, this boundary surface being oriented toward the intermediate shell 17, rests on the second spacers 251 and 252, which project in relation to the second boundary surface 21 by for example 30 μm to 1500 μm, this thereby defining the spacing between the inner shell 16 and the intermediate shell 17. The two shells 16 and 17 are preferably adhesively bonded to one another, so that the spacing pre-defined by the second spacers 251 and 252 is maintained during the adhesive-bonding process (or the joining process). Use can be made for example of an adhesive 27 of which the refractive index is adapted to that of the basic material of the intermediate and inner shells 17, 16. Total internal reflection at the rear side 9 can thus be used in order to ensure light guiding.

The image-generating module 5 and the spectacle lens 3 are designed in such a manner that a user who is wearing the display device 1 on his head can perceive as a virtual image the image generated by means of the image-generating module 5. Depending on the reflectivity of the deflecting elements 14, the user can perceive the virtual image superimposed with the surroundings. In the case of a very high reflectivity, and in particular in the case of a reflectivity of 100%, the user can perceive only the virtual image, and not the surroundings, at least in the region of the deflecting portion 12, unless the deflecting elements 14 are spaced apart to the extent where ambient light still reaches the viewer's eye between the individual deflecting elements 14 of the deflecting portion 12 and he can perceive the surroundings in this way.

An advantageous way of producing the intermediate shell 17 can be for example by a forming process or for example by an injection-molding process using an appropriate mold 30, as is illustrated schematically in FIG. 4. It is thereby possible to produce the intermediate shell 17 with the elevated spacers 221 and 222 and also 251 and 252 with the desired level of accuracy (even when large numbers of items are being manufactured).

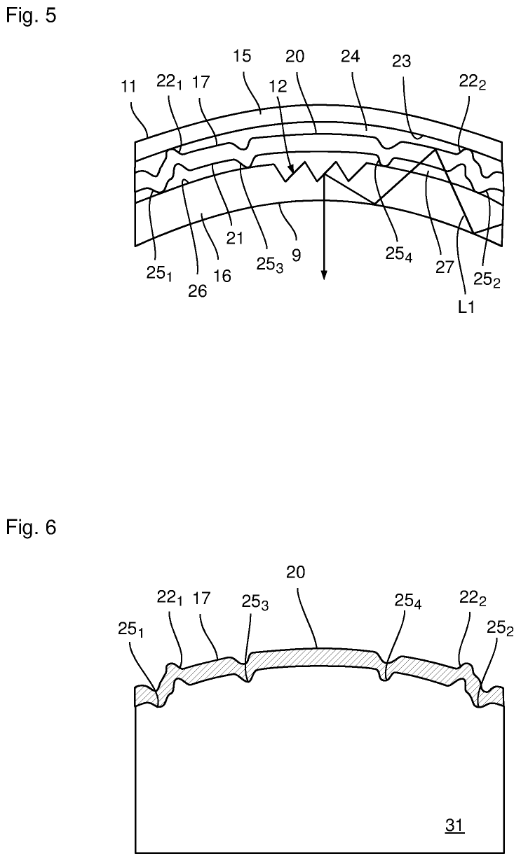

FIG. 5 shows a variation of the spectacle lens 3 and in particular of the intermediate shell 17.

This variation provides further second spacers 253 and 254, which in the finished spectacle lens 3 are in the vicinity of the reflective deflecting elements 14. An appropriate mold 31 for producing the intermediate shell 17 according to FIG. 5 is shown in FIG. 6.

The display device 1 can also be designed in such a manner that the left-hand spectacle lens 4 is designed in the form of a multifunctional lens, as has been described in combination with FIGS. 1 to 6. In this case, the image-generating module 5 is preferably arranged in the region of the left-hand spectacle earpiece. It is also possible for both the left-hand spectacle lens 4 and right-hand spectacle lens 3 to be designed in the form of multifunctional lenses, wherein a separate image-generating module 5 is preferably provided for each spectacle lens 3, 4 (preferably in the left-hand and right-hand spectacle earpieces).

The deflecting portion 12 can provide for straightforward beam deflection. It can preferably provide an imaging effect in addition.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

1-10. (canceled)

11. A spectacle lens for a display device which can be placed on the head of a user and generate an image, the spectacle lens comprising:
a front side;
a rear side;
an entry portion;
a deflecting portion, which is spaced apart from the entry portion;
an exit portion in the rear side; and
a light-guiding channel,
wherein bundles of light from the generated image that are coupled into the spectacle lens via the entry portion of the spectacle lens are guided via the light-guiding channel in the spectacle lens, via at least one reflection, as far as the deflecting portion, from which they are deflected in a direction of the exit portion and are then coupled out of the spectacle lens by way of the exit portion,
wherein the spectacle lens is of multi-shell construction and comprises a first shell, a second shell and a third shell,
wherein the second shell is arranged between the first and third shells and is connected to the first and third shells,
wherein the second shell comprises a first boundary surface, which is oriented toward the first shell, and a second boundary surface, which is oriented toward the third shell,
wherein the second shell comprises at least one first spacer, which projects in relation to the first boundary surface and pre-defines the spacing between the second and first shells, and at least one second spacer, which projects in relation to the second boundary surface and pre-defines the spacing between the second and third shells.

12. The spectacle lens of claim 11, wherein the at least one first spacer and the at least one second spacer are formed in one piece with the second shell.

13. The spectacle lens of claim 11, wherein the first and third shells are free of spacers.

14. The spectacle lens of claim 11, wherein the first and second shells are connected via a first adhesive layer and the second and third shells are connected via a second adhesive layer.

15. The spectacle lens of claim 11, wherein the deflecting portion is formed in the third shell.

16. The spectacle lens of claim 11, wherein the deflecting portion comprises a plurality of reflective deflecting elements arranged one beside the other.

17. The spectacle lens of claim 16, wherein a structure for the reflective deflecting elements that pre-defines geometrical dimensions is formed in one piece with the third shell.

18. The spectacle lens of claim 11, wherein the light-guiding channel is formed in the second and third shells.

19. The spectacle lens of claim 11, wherein the two boundary surfaces are curved.

20. A display device comprising:
a holding device, which can be placed on the head of a user;
an image-generating module, which is fastened on the holding device and generates an image; and
the spectacle lens of claim 11, which is fastened on the holding device and, in the state in which the holding device has been placed on the head, projects the generated image in such a manner that the user can perceive it as a virtual image.
